(19) United States
(12) Patent Application Publication
(10) Pub. No.: US 2010/0187389 A1
(43) Pub. Date: Jul. 29, 2010

(54) Transparent mounting strip

(76) Inventors: Alicia K. Gelfond-Holtz, Atlanta, GA (US); Louis E. Holtz, Atlanta, GA (US)

Correspondence Address: LITMAN LAW OFFICES, LTD., POST OFFICE BOX 41200, SOUTH STATION, ARLINGTON, VA, 22204, US

(21) Appl. No.: 12/662,046

(22) Filed: Mar. 29, 2010

Related U.S. Application Data
(63) Continuation-in-part of application No. 11/638,392, filed on Dec. 14, 2006, now abandoned.
(60) Provisional application No. 60/759,619, filed on Jan. 18, 2006.

(51) Int. Cl. F16M 13/02

(52) U.S. Cl. 248/217.3

(57) ABSTRACT

The transparent mounting strip provides a structure for mounting lightweight articles to planar surfaces, such as walls, corkboards, display boards and the like. The structure includes a strip fabricated from transparent material. A tack is embedded or attached at each end of the strip and extends from the undersurface thereof. The strip can be manufactured in various lengths to accommodate different sized articles and can be made in different colors to accommodate aesthetic tastes. The strip can be relatively stiff or highly flexible, depending on the intended use.

### CROSS-REFERENCE TO RELATED APPLICATION

This application is a continuation-in-part of U.S. patent application Ser. No. 11/638,392, filed Dec. 14, 2006, which claims the benefit of U.S. Provisional Patent Application Ser. No. 60/759,619, filed Jan. 18, 2006.

### BACKGROUND OF THE INVENTION

1. Field of the Invention

The present invention generally relates to support structures. More specifically, the present invention is drawn to a strip for fastening lightweight art and articles to planar surfaces.

2. Description of the Related Art

Mounting favorite photographs, children's drawings, postcards and similar lightweight articles to walls or bulletin boards often presents problems in that many presently-used mounting structures obscure a portion of the mounted article or worse, cause damage to the article. Three dimensional and irregular shaped objects (CD jewel cases, toys, etc.) have been especially challenging to quickly and easily mount to walls and boards for display. The art would certainly welcome a mounting structure that can be easily and quickly attached to a planar surface to support a desired article without marring or obscuring the article.

Thus, a transparent mounting strip solving the aforementioned problems is desired.

### SUMMARY OF THE INVENTION

The transparent mounting strip incorporates a structure for mounting articles to planar surfaces, such as walls, corkboards, display boards and the like. In its basic form, the transparent mounting strip comprises a strip fabricated from transparent material. A respective pin or tack is embedded or attached at each end of the strip and extends from the undersurface thereof. The strip can be manufactured in various lengths to accommodate differently sized articles and can be made in different colors to accommodate aesthetic tastes. The strip can be relatively stiff or highly flexible, depending on the intended use. The strip can also incorporate gripping portions positioned on its upper surface.

Accordingly, the invention presents mounting structures that allow for the display of lightweight art and/or articles without fear of damage or obstruction. As contemplated, the invention is usable in the home or office. Professional artists and photographers can also find use for the mounting structures. The structures are fabricated from transparent material and are designed to effect quick and easy mounting. The invention provides for improved elements thereof in an arrangement for the purposes described that are inexpensive, dependable and fully effective in accomplishing their intended purposes.

A clear understanding of the present invention will become readily apparent upon further review of the following specification and drawings.

### BRIEF DESCRIPTION OF THE DRAWINGS

FIG. 1 is an environmental, perspective view of a transparent mounting strip according to the present invention.

FIG. 2 is a perspective view of a first embodiment of a transparent mounting strip according to the present invention.

FIG. 3 is a perspective view of a second embodiment of a transparent mounting strip according to the present invention.

FIG. 4 is a perspective view of a third embodiment of a transparent mounting strip according to the present invention.

FIG. 5 is a perspective view of a fourth embodiment of a transparent mounting strip according to the present invention.

FIG. 5A is a section view taken along lines 5A-5A of FIG. 5.

FIG. 6 is a bottom, perspective view of the mounting strip of FIG. 5 according to the present invention.

FIG. 7 is a side view in section of the mounting strip of FIG. 5 according to the present invention.

FIG. 8A is a perspective view of an embodiment of a tack utilized in a transparent mounting strip according to the present invention.

FIG. 8B is a perspective view of another embodiment of a tack utilized in a transparent mounting strip according to the present invention.

Similar reference characters denote corresponding features consistently throughout the attached drawings.

### DETAILED DESCRIPTION OF THE PREFERRED EMBODIMENTS

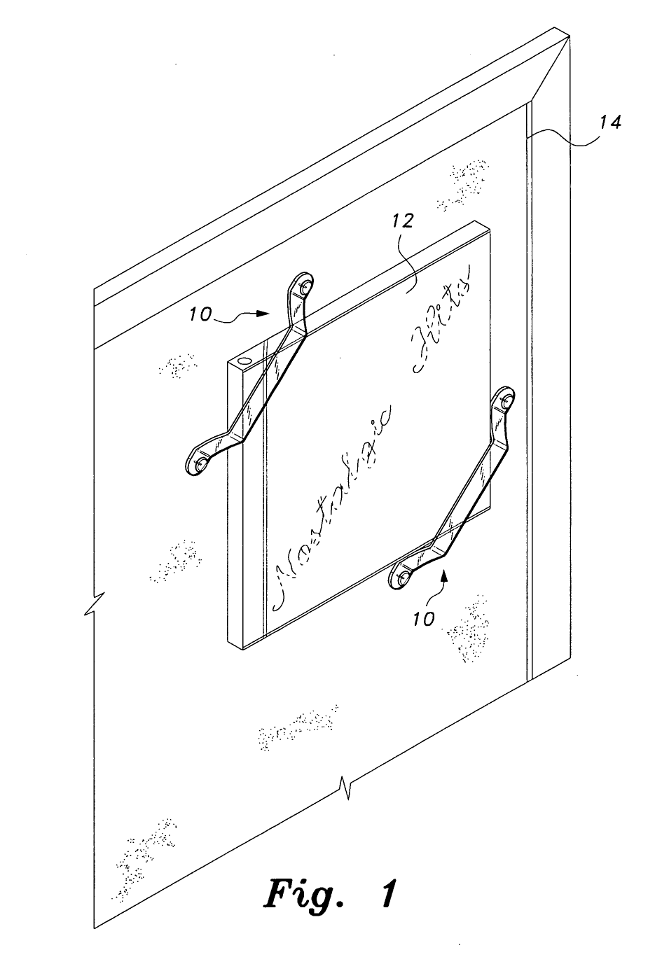

Attention is first directed to FIG. 1, wherein a pair of transparent mounting strips is generally indicated at 10. The strips 10 are shown being used to mount a CD case 12 for display. As shown, the CD case 12 is mounted to a corkboard or bulletin board 14. As indicated above, the strips 10 can be employed to mount a variety of articles, including stuffed animals, dolls, legos, three dimensional art, etc.

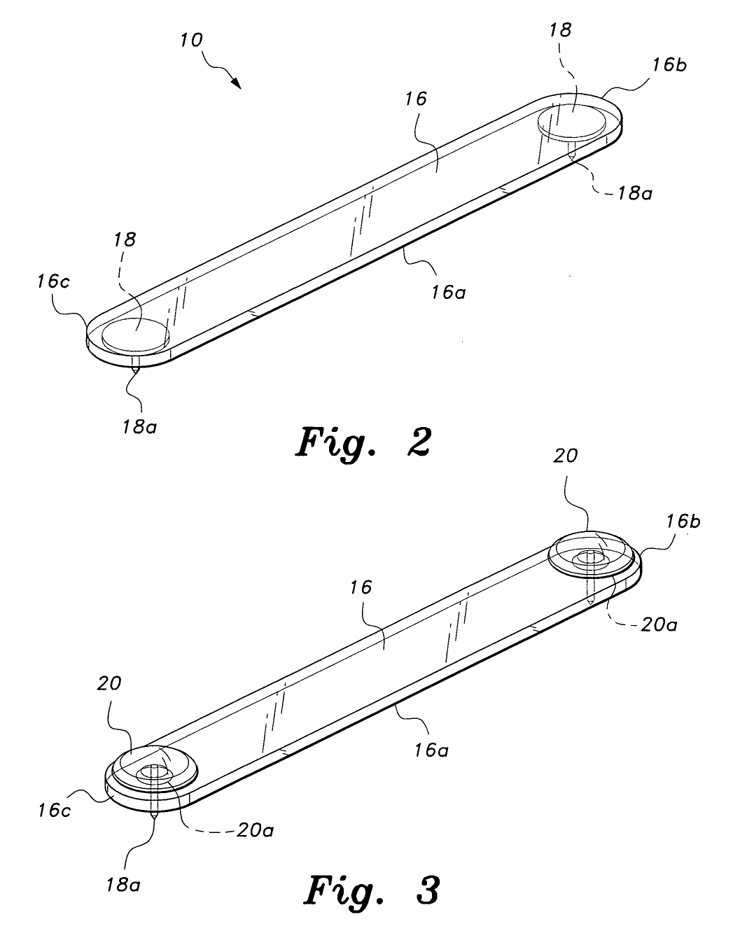

A first embodiment of a strip 10 is illustrated in FIG. 2. The strip 10 is fabricated from a relatively stiff, transparent material having an upper surface 16 and an undersurface 16a. The ends of the strip are defined at 16b and 16c. The transparent head 18 of a respective pin or tack is embedded adjacent each end of the strip 10, the pin shaft extending from the undersurface 16a. The tack terminates in a sharp point 18a.

The embodiment of FIG. 3 is similar to that of FIG. 2, except that the pins or tacks 20 have a head that protrudes through or above the upper surface 16. Each tack 20 has a substantially flat top that can be inscribed or otherwise provided with a design, logo, trademark, etc. thereon. Each tack 20 may be provided with a tiny lip 20a to provide for enhanced manipulation of strips 10.

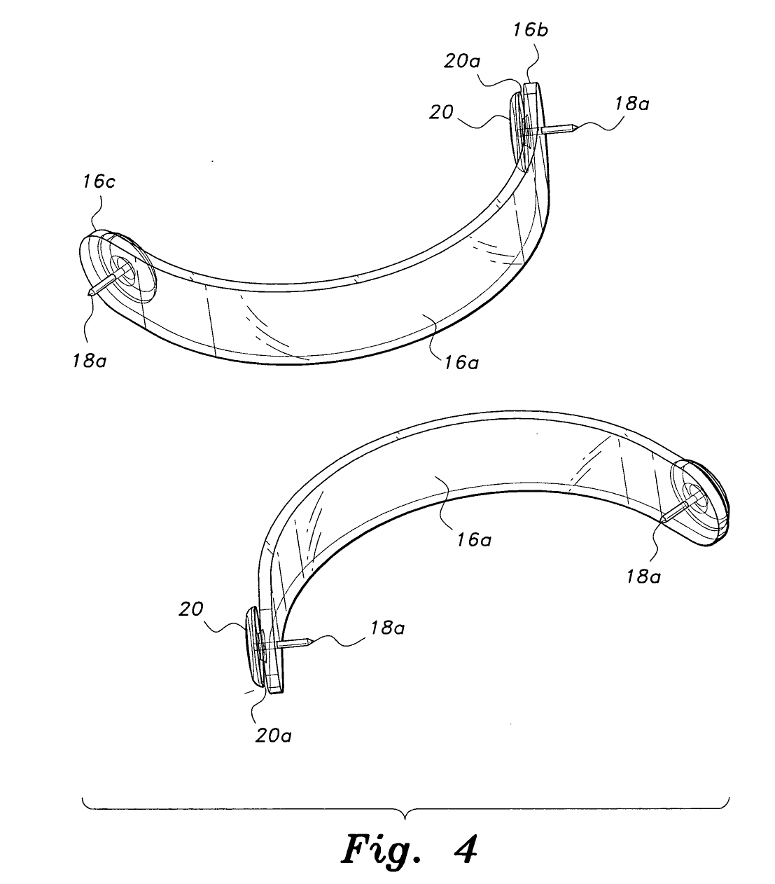

As best seen in FIG. 4, the alternative strip 10 is fabricated from a material that can be easily flexed, as opposed to the relatively stiff material disclosed in FIGS. 2 and 3. It is obvious that both embodiments (the embodiments of FIGS. 2 and 3) could employ either flexible or relatively stiff material, depending on the intended use.

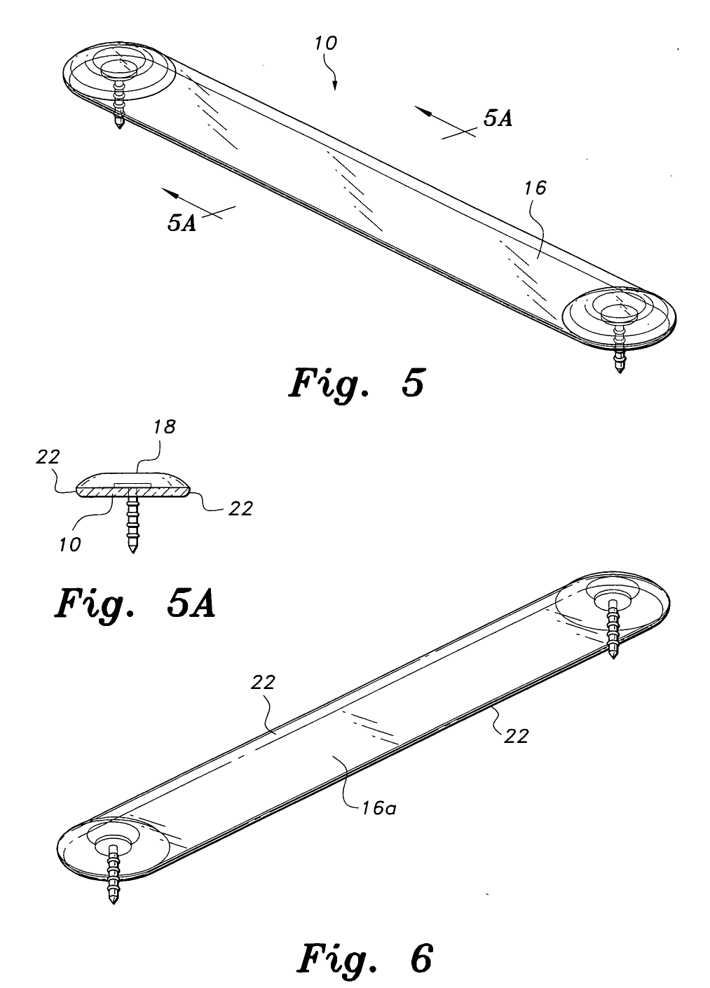

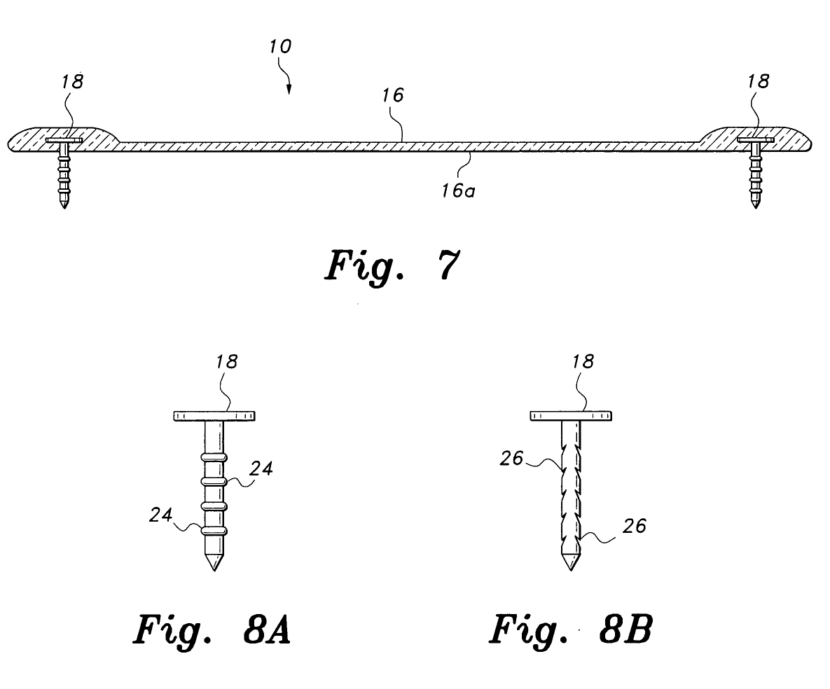

The embodiments described above are produced by stamping the strips from a plastic sheet. This method of manufacture is the quickest and cheapest way to produce the strips. It was determined, however, that strips produced by this method had relatively well defined sharp and/or rough edges. While the above-described strips are usable to support many displays (e.g., jewel cases for CDs), the rough or sharp edges on the undersurface thereof might produce scratches and pressure lines on works of fine art, photographs, and the like. To alleviate this problem, the embodiment of the transparent mounting strip 10 illustrated in FIGS. 5-7 is manufactured by plastic molding processes in order to provide rounded edges 22, as shown in FIG. 5A. This structural arrangement prevents any damage to the above-mentioned works of fine art, photographs, paper articles, newspaper clippings, etc. The tack head 18 is molded into the strip 10 to ensure that the tack will not pull away from the strip 10.

As best seen in FIGS. 8A and 8B, the shanks or shafts of the tacks are formed with protrusions that may include rings 24 (similar to the annular rings on the shank of a drywall nail for gripping the substrate or subsurface), indentations 26, or similar structure to provide increased friction for a better hold in planar surfaces made of such material as sheetrock or the like.

To use, the user partially inserts the tacks into the planar surface of the wall or board, places the edges of the article beneath the strip 10 between the tacks and pushes the tacks in the wall or board to secure the article thereon.

It is to be understood that the present invention is not limited to the embodiments described above, but encompasses any and all embodiments within the scope of the following claims.

We claim:

1. A device for mounting articles on a planar surface comprising:
a transparent strip having an upper surface, an under surface, a first end, a second end, a rounded first edge and a rounded second edge;
a first tack having a head positioned adjacent the first end of the transparent strip and a first shank extending from the head of the first tack, the first shank extending from the under surface and terminating in a point; and
a second tack having a head positioned adjacent the second end of the transparent strip and a second shank extending from the head of the second tack, the second shank extending from the under surface and terminating in a point.

2. The device for mounting articles according to claim 1, wherein said transparent strip is fabricated from a stiff material.

3. The device for mounting articles according to claim 1, wherein said transparent strip is fabricated from a flexible material.

4. The device for mounting articles according to claim 1, wherein the head of said first tack and the head of said second tack are embedded in said transparent strip.

5. The device for mounting articles according to claim 1, wherein the first shank and the second shank each have an irregular outer surface.

6. A device for mounting articles on a planar surface comprising:
a transparent strip having an upper surface, an under surface, a first end, a second end, a rounded, elongated first edge, and an opposing rounded, elongated second edge, the edges extending from the upper surface to the under surface;
a first tack having a head positioned adjacent the first end of the transparent strip and a first shank extending from the head of the first tack, the first shank extending from the under surface and terminating in a point; and
a second tack having a head positioned adjacent the second end of the transparent strip and a second shank extending from the head of the second tack, the second shank extending from the under surface and terminating in a point;

7. The device for mounting articles according to claim 6, wherein said transparent strip is fabricated from a stiff material.

8. The device for mounting articles according to claim 6, wherein said transparent strip is fabricated from a flexible material.

9. The device for mounting articles according to claim 6, wherein the head of said first tack and the head of said second tack are embedded in said transparent strip.

10. The device for mounting articles on a planar surface according to claim 6, wherein the first shank and the second shank each have an irregular outer surface.

11. The device for mounting articles on a planar surface according to claim 10, wherein said irregular surface has a plurality of protruding rings.

12. The device for mounting articles on a planar surface according to claim 10, wherein said irregular surface has indentations therein.
